(19) United States
(12) Patent Application Publication
(10) Pub. No.: US 2017/0339841 A1
(43) Pub. Date: Nov. 30, 2017

(54) SYSTEM AND METHOD FOR MODULAR GARDEN

(71) Applicant: Fernando Ortiz Monasterio, Delegación Miguel Hidalgo (MX)

(72) Inventor: Fernando Ortiz Monasterio, Delegación Miguel Hidalgo (MX)

(21) Appl. No.: 15/609,357

(22) Filed: May 31, 2017

Related U.S. Application Data
(60) Provisional application No. 62/343,400, filed on May 31, 2016.

(51) Int. Cl. A01G 9/02; A01G 7/04; A01G 27/00

(52) U.S. Cl. CPC A01G 9/02; A01G 27/005; A01G 7/045; A01G 9/025; A01G 27/003

(57) ABSTRACT

Systems and methods for providing and operating a modular garden are provided. Modular gardens of the present technology may be attached to an indoor or outdoor wall. Modular gardens of the present technology include modular planters having at least one panel, a watering system, and a garden computing system that monitors plant conditions, automatically waters plants in the modular garden, and may communicate with a user personal computing device.

### CROSS-REFERENCE TO RELATED APPLICATION

This application claims priority to and the benefit of U.S. Provisional Patent Application No. 62/343,400, filed on May 31, 2016, the disclosure of which is incorporated herein by reference in its entirety.

### BRIEF DESCRIPTION OF SEVERAL VIEWS OF THE DRAWINGS

Specific examples have been chosen for purposes of illustration and description, and are shown in the accompanying drawings, forming a part of the specification.

FIG. 1 illustrate one example of a modular garden system of the present technology.

FIG. 2 illustrates the modular garden system of FIG. 1, with the plant pods removed.

FIG. 3 illustrates a modular planter of the modular garden system of FIG. 1.

FIG. 4 illustrates a water collector of the modular garden system of FIG. 1.

FIG. 5 illustrates one example of a watering system of the modular garden system of FIG. 1.

FIG. 6 illustrates one example of a control system of a modular garden system of FIG. 1.

FIG. 7 illustrates a front view second example of a modular garden system of the present technology.

FIG. 8 illustrates a side view of the modular garden system of FIG. 5.

FIG. 9 illustrates a rear view of the modular garden system of FIG. 5, with certain components removed.

FIG. 10 illustrates a watering system and an air delivery system of the modular garden system of FIG. 5.

FIG. 11 illustrates a rear view of the modular garden system of FIG. 5, with sensors.

FIG. 12 illustrates a front view of one example of a plant pod of the present technology.

FIG. 13 illustrates a rear view of the plant pod of FIG. 12.

FIG. 14 illustrates a second example of a plant pod of the present technology.

FIG. 15 illustrates one example of a control system of a modular garden system of FIG. 5.

### DETAILED DESCRIPTION

The present technology provides systems and methods for providing and operating a modular garden. modular gardens of the present technology can be used to grow plants in various locations, and in some examples are particularly suited for use on indoor or outdoor walls, such as in homes, office spaces, classrooms, or any other wall, or non-horizontal substrate where it would be desirous to have plants. The present technology can be used to grow a potentially unlimited variety of plants, including for example food, ornamental, and medicinal plants.

Modular garden systems of the present technology include several components, such as a modular planter, a garden computing system, and a watering system, all of which are operatively connected to provide a system that contains plants, monitors plant related conditions, and automatically waters plants.

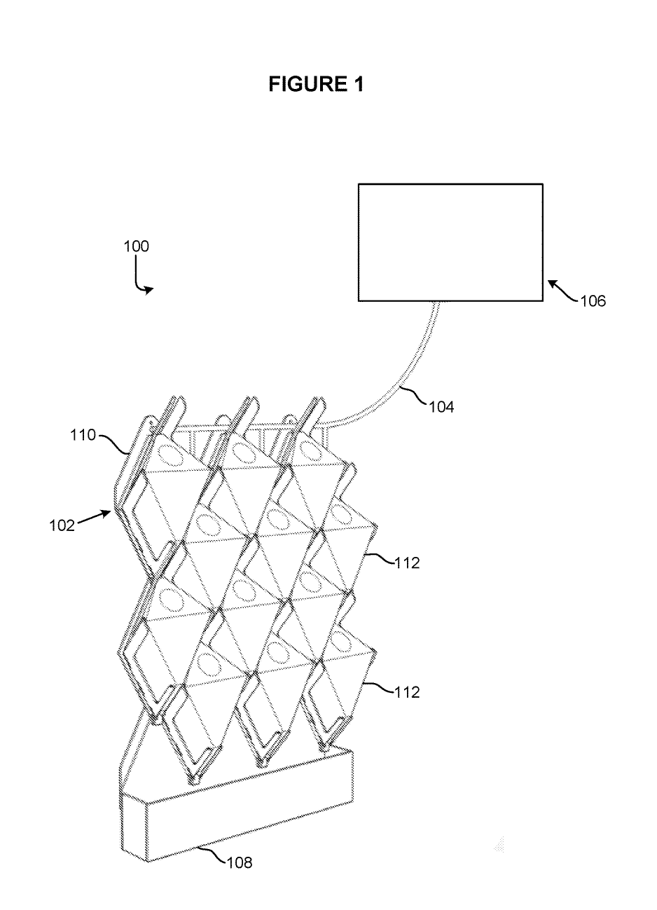

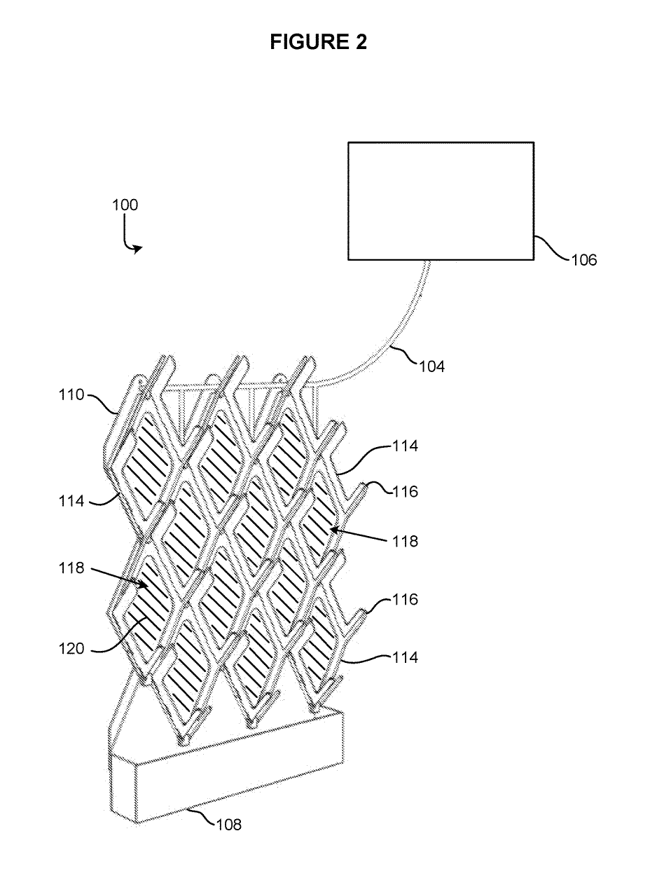

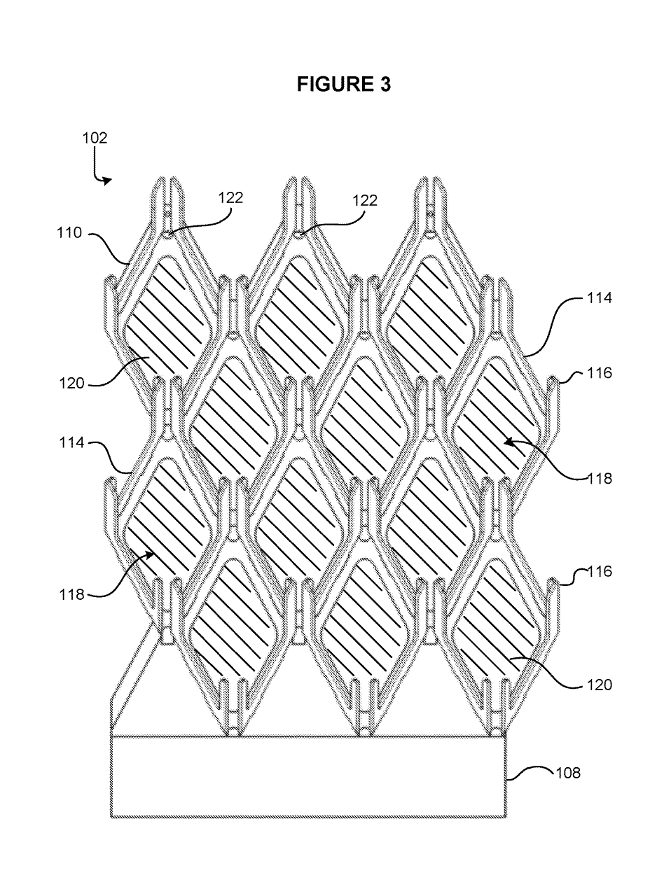

FIGS. 1-3 illustrate one example of a modular garden system 100 of the present technology. The modular garden system 100 includes a modular planter 102, a watering system 104 operatively connected to the modular planter, and a control system 106 operatively connected to the watering system. The illustrated example also includes a water collector 108.

The modular planter 102 includes at least one base panel 110, which is configured to receive one or more plant pods 112. The base panel 110 is configured to be attached to a surface, which may be a vertical surface such as a wall, including for example an interior or exterior wall of a building. The modular planter 102 may include any number of panels suitable for use in the desired space. Each base panel 110 is configured to be connectable to one or more other base panels, which may allow the formation a modular planter 102 having any of a plurality of configurations of interconnected base panels 110.

Each base panel 110 includes one or more plant pod receivers 114. Each plant pod receiver 114 includes at least one arm 116 and a back wall 118. Each plant pod receiver 114 is configured to slidably receive and contain a plant pod 112, and connect the plant pod to the watering system 104. For example, the illustrated example shows each plant pod receiver 114 as having four arms 116, which are configured to slidably receive a plant pod 112. Each arm 116 protrudes away from the back wall 118 of the plant pod receiver 114 at an upward angle.

Each base panel 110 is configured for hydroponic growth of plants in the plant pods 112. As shown, the back wall 118 of each plant pod receiver 114 may include a growth substrate 120. The growth substrate 120 may be a bio-foam, which may be biodegradable.

Each base panel 110 also includes at least one channel 122, through which water may be received and flow through the panel to either another panel or to the water collector 108. Each channel 122 receives water from the reservoir 500 of the watering system 104 and provides the received water to at least one plant pod. At least one channel 122 is connected to the watering system 104, and in some examples, each channel 122 may be connected to the watering system 104.

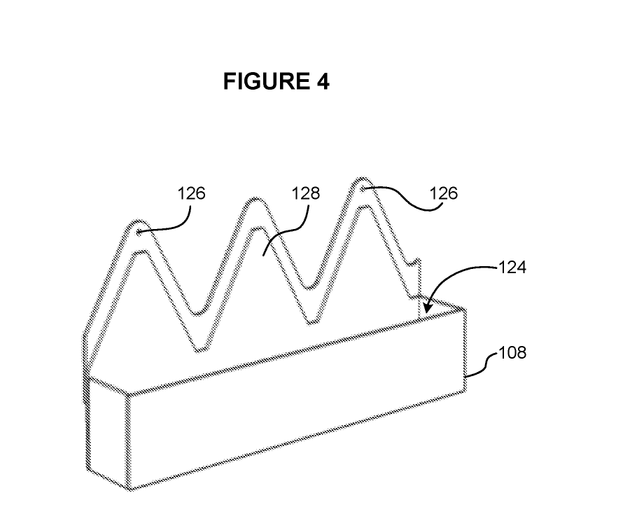

FIG. 4 illustrates one example of a water collector 108 that can be used with modular garden system 100. The water collector 108 may include a trough 124, or other water collection and storage container. The water collector 108 may connect to a base panel 110 at one or more connection points 126, using any suitable fastener, such as a hook or screw. The water collector 108 may have a back wall 128, configures to direct water from the channels 122 into the trough 124. The water collector 108 may collect run-off water, which is water used for watering the plants that does not get taken up by the plants and growth substrate in the modular garden. The water collector 108 may be located at the bottom of the base panel 110, and the water collected therein may be reused in the modular garden system.

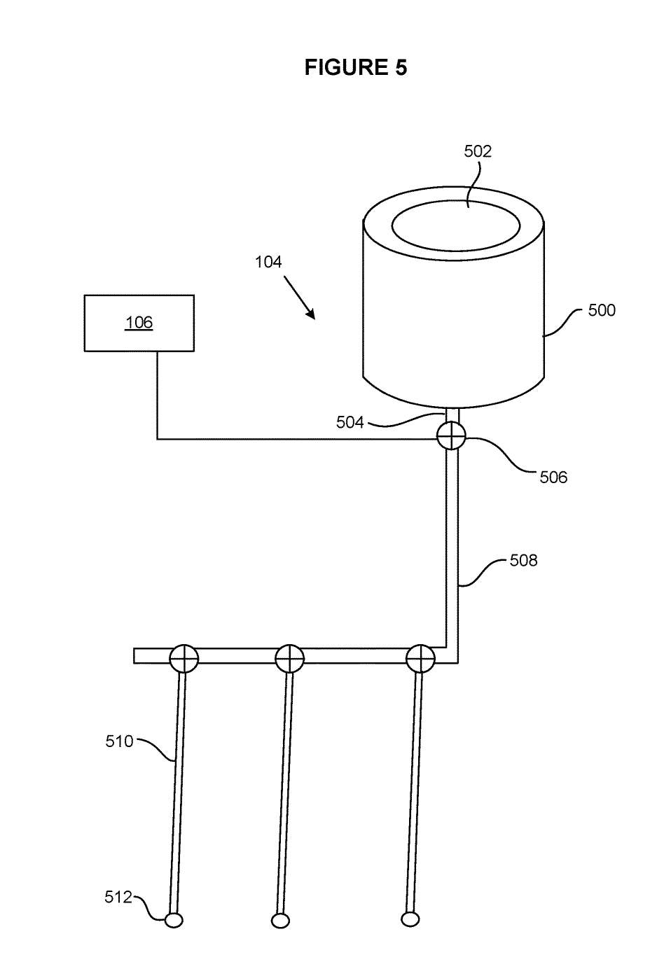

FIG. 5 illustrates one example of a watering system 104 that can be used with modular garden system 100. The watering system 104 includes a reservoir 500, which is configured to hold water. The reservoir has an inlet 502, through which the reservoir can receive water. For example, a user may pour water into the reservoir 500 through the inlet 502. The reservoir 500 may have a capacity that allows the system to water plants for a period of time without additional water supply. The capacity of the reservoir 500 may be designed to allow for watering over any suitable amount of time, including about a day, about a week, about a month, or for shorter or longer periods of time. The reservoir 500 also has an outlet 504, though which water may exit the reservoir and be conveyed to the plant pods. The outlet 504 may include a valve 506, which is operatively connected to the control system 106. Control system 106 may open or close the valve, as appropriate, to provide sufficient water to the plant pods to promote growth. The watering system 104 also includes a main pipe 508 that conveys water from the outlet 504 of the reservoir 500 to one or more watering pipes 510. Each watering pipe 510 has a connector 512, which is configured to connect to a channel 122 and deliver water to at least one plant pod. Water may be conveyed from the reservoir 500 through the channels 122 using a pump, or gravity.

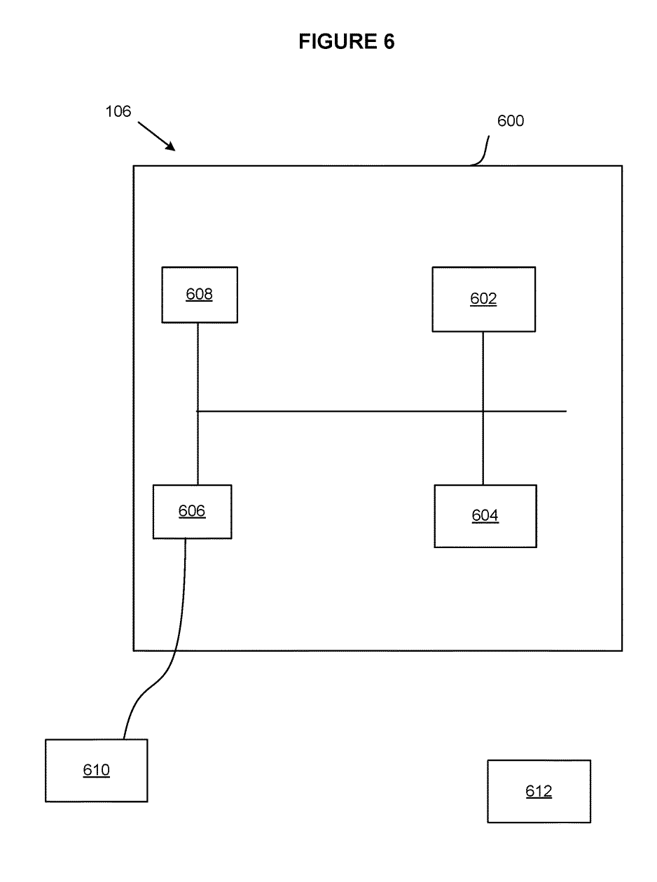

FIG. 6 illustrates one example of a control system 106 that can be used with modular garden system 100. The control system 106 may include a housing 600. Water reservoir 500 of the watering system 104, as show in in FIG. 5, may be housed within the housing 600, along with the control system 106. The control system 106 includes a processor 602, a non-volatile computer readable memory 604 operatively connected to the processor, a receiver 606 operatively connected to the processor and the memory, a transmitter 608 operatively connected to the processor and the memory, and at least one sensor 610. Each sensor 610 may be located in contact with at least one plant pod 112, and may be operatively connected to the receiver 606 of the control system 106. The operative connection may be wired, or wireless. The non-volatile computer readable memory 604 may store computer readable instructions, such as software code, that when executed by the processor 602, cause the control system 106 to operate the modular garden system 100, including the watering system 104. For example, when sensor 610 sends a signal to the receiver 606, indicating that the moisture level in a plant pod 112 is low, the control system 106 may cause the valve 502 of the watering system 104 to open, to provide water to the plant pod 112. The control system 106 may also send data from the transmitter 608 to a remote receiver 612, such as a user smartphone or other personal computing device.

The at least one sensor 610 can be a plant condition sensor. Each plant condition sensor 610 may measure one or more conditions relating to plants in the modular planter, including the humidity of the soil, the ambient temperature, and the amount of light the plants receive. Each plant condition sensor 610 may collect data and transmit the data to the control system 106.

The modular garden system 100 may optionally include one or more software applications that can be run on the remote receiver 612, such as a user's personal computing device. The one or more software applications may allow the user to share the status of plants on social media and establish relationships with other users in a geographic vicinity. Information that can be shared between users includes, for example, plant production information, tips on modular gardening and modular garden operation, and recipes. In at least one example, users may be provided with an account that allows them to log into a central system to communicate with other users, access an on-line store for modular garden components, plants and related merchandise, and participate in a rewards program that provides points unable in the on-line store.

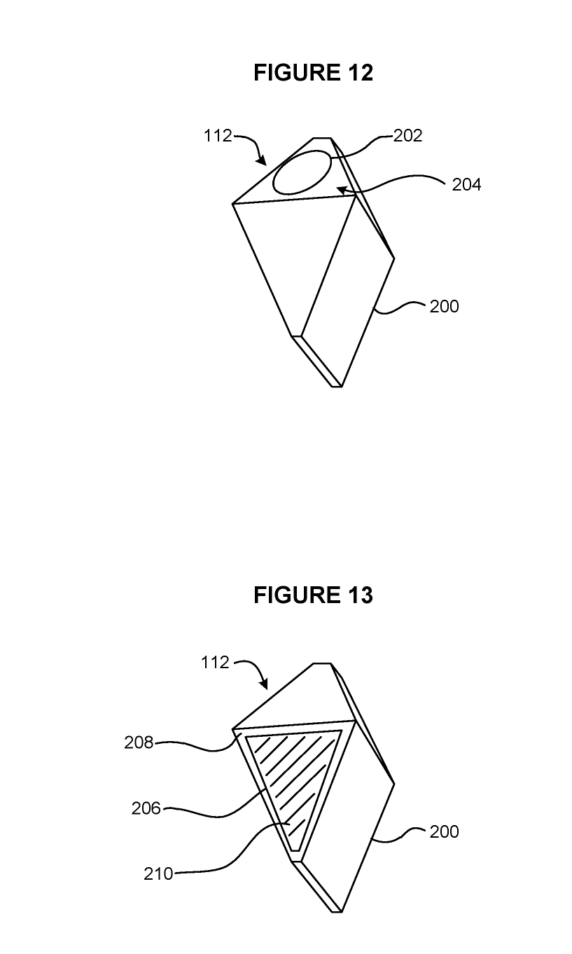

FIGS. 12 and 13 illustrate one example of a plant pod 112 that can be used with modular garden system 100. The plant pod has a housing 200, a plant growth opening 202 on a front side 204 of the housing 200, and a substrate interface 206 on a back side 208 of the housing 200. Inside the plant pod 112, there is a plant growth substrate 210. The plant growth substrate 210 may be the same material, or a different material, as growth substrate 120. plant growth substrate 210 may be may be a bio-foam, which may be biodegradable. When the plant pod 112 is received by the plant pod receiver 114, the plant growth substrate 210 is in contact with growth substrate 120. Plant pod 112 also contains one or more seeds or seedlings, not shown. As the one or more seeds or seedlings grow, the resulting plant or plants protrude through the plant growth opening 202 on a front side 204 of the housing 200.

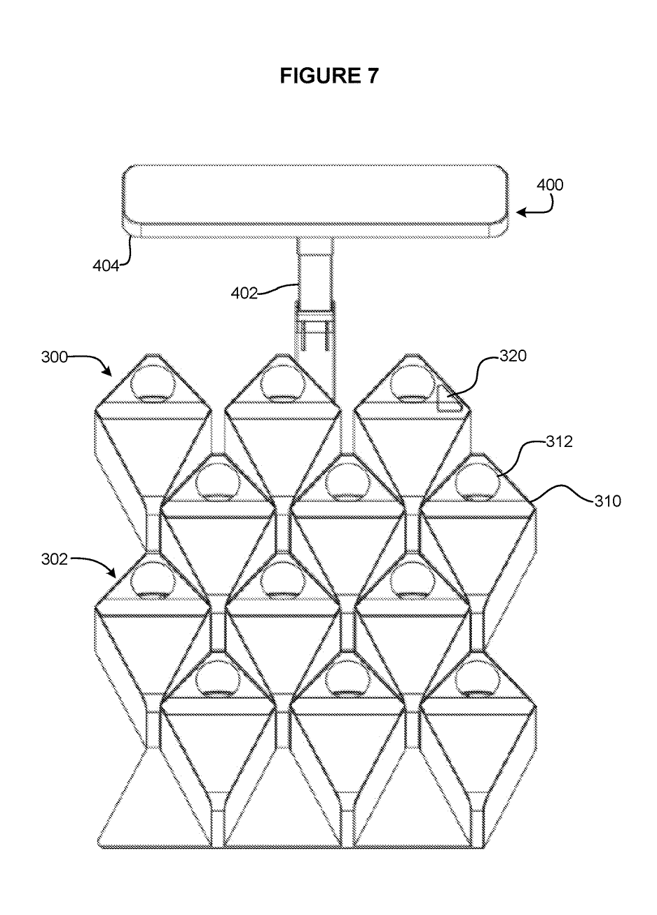

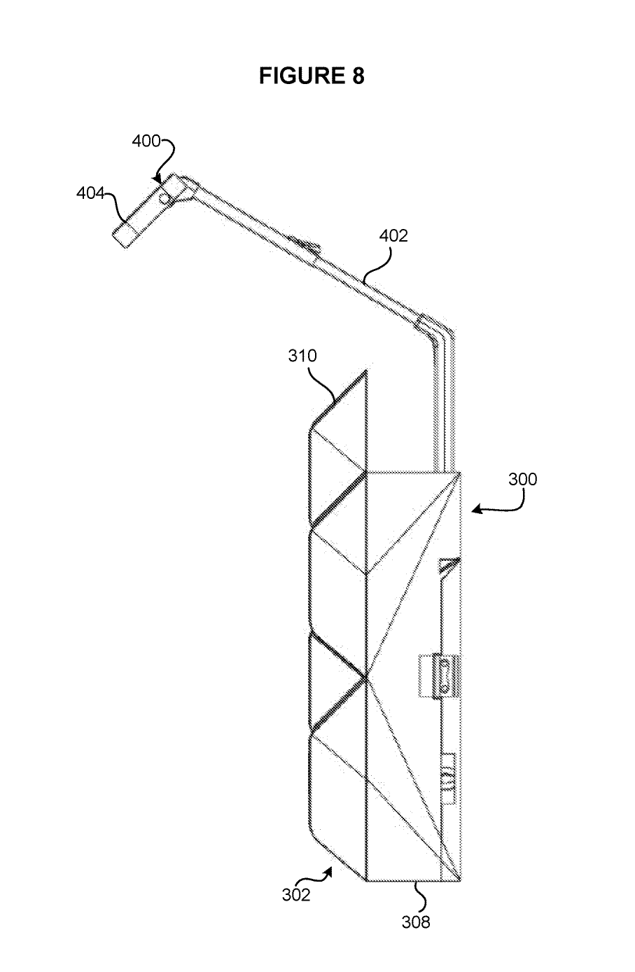

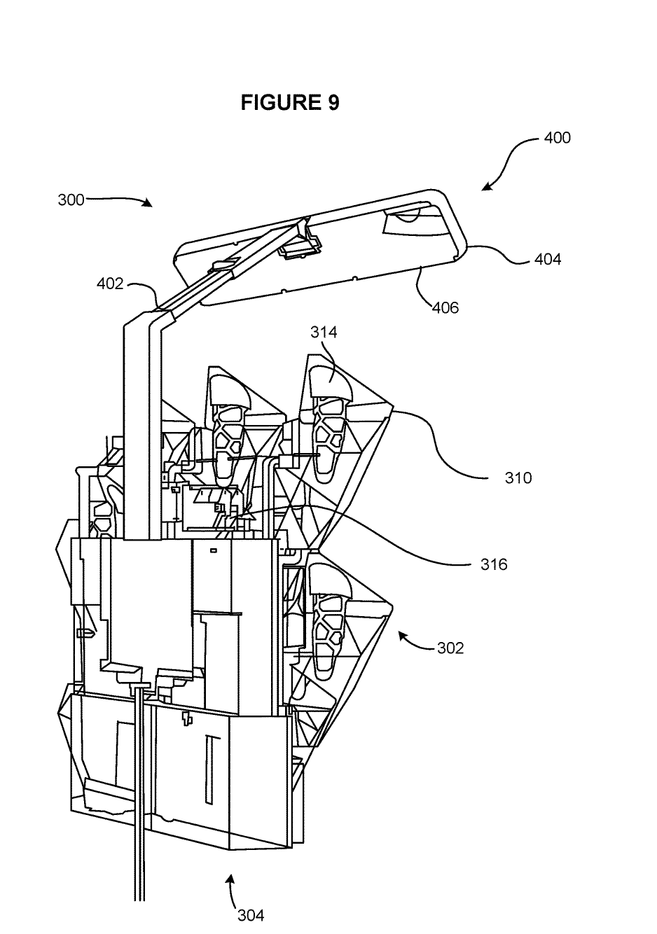

FIGS. 7-11 illustrate another example of a modular garden system 300 of the present technology. The modular garden system 300 includes a modular planter 302, a watering system 304 operatively connected to the modular planter 302, and a control system 306 operatively connected to the watering system.

The modular planter 302 includes at least one base panel 308. The base panel 308 is configured to be attached to a surface, which may be a vertical surface such as a wall, including for example an interior or exterior wall of a building. The modular planter 302 may include any number of base panels suitable for use in the desired space. Each base panel 308 is configured to be connectable to one or more other base panels, which may allow the formation a modular planter 302 having any of a plurality of configurations of interconnected base panels 308.

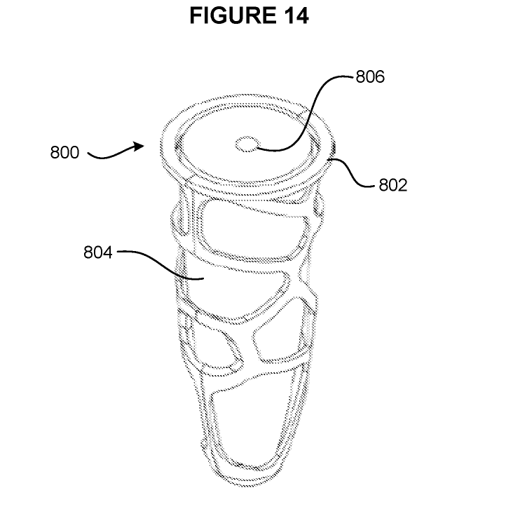

Each base panel 308 includes one or more plant pod receivers 310. Each plant pod receiver 310 is configured to slidably receive and contain a plant pod 800 (FIG. 14), and connect the plant pod to the watering system 304. For example, the illustrated example shows each plant pod receiver 310 as having a receiving aperture 312 and a holder 314 that slidably receive and hold the plant pod 800.

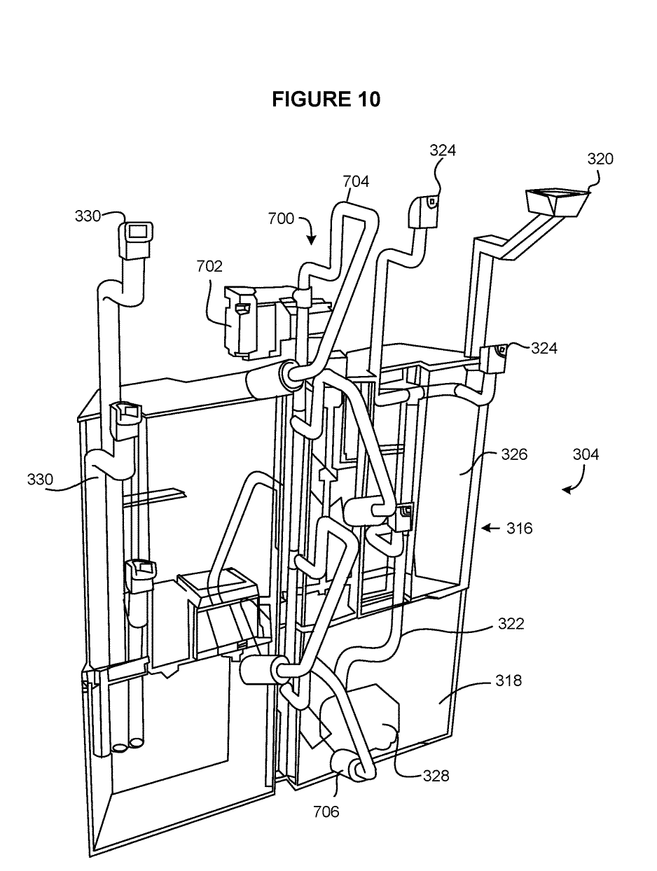

FIG. 10 illustrates one example of a watering system 304 that can be used with modular garden system 300. The watering system 304 includes a reservoir 316, which is configured to hold water. The reservoir 316 has an inlet 320, through which the reservoir can receive water. For example, a user may pour water into the reservoir 316 through the inlet 320. The reservoir 316 may have a capacity that allows the system to water plants for a period of time without additional water supply. The capacity of the reservoir 316 may be designed to allow for watering over any suitable amount of time, including about a day, about a week, about a month, or for shorter or longer periods of time. The reservoir 316 may include a filling tank 326 and a pumping chamber 318. The filling tank 326 and the pumping chamber 318 may be separate, each holding a volume of water, and may be connected via a valve (not shown) that may be connected to the control system 306. The reservoir 316 also has an outlet 322, though which water may exit the reservoir 316 and be conveyed through at least one channel 324 to the plant pods. The outlet 322 may include a pump 328 and/or valve that is operatively connected to the control system 306. Control system 306 may operate pump and/or valve, as appropriate, to provide sufficient water to the plant pods to promote growth.

Watering system 304 may also include a water collector that collects run-off water, such as at least one gutter 330. Each gutter 330 is configured to connect to one or more plant pod receivers 310. Each gutter directs run-off water from the one or more plant pod receivers 310 to the pumping chamber 318. Water collected by each gutter 330 and returned to the pumping chamber 318 may be combined with water received through the inlet 320 and reused in the watering system 304.

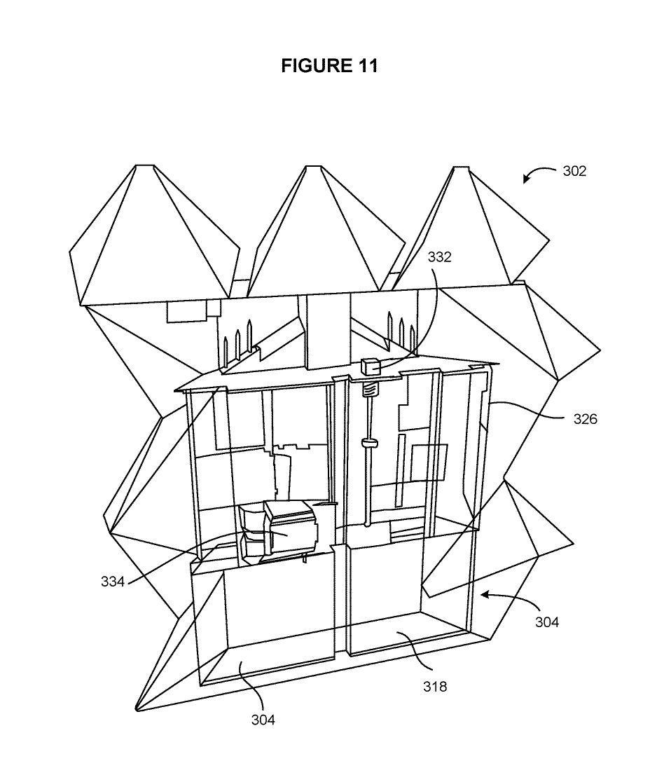

FIG. 11 shows two sensors 332 and 334 that may be part of the watering system 304. First sensor 332 detects the level of the water in the filling tank 326. Second sensor 334 detects the level of the water in the pumping chamber 318. Each of the sensors may be operatively connected to the control system 306. The operative connection may be wired or wireless. The control system may receive data from first sensor 332 and second sensor 334 to determine the water level in the watering system 304, including in the filling tank 326 and the pumping chamber 318. When the water level in the pumping chamber 318 is low, the control system 306 may cause the valve between the filling tank and the pumping chamber to open, and thus transfer water from the filling tank 326 to the pumping chamber 318. When the water level in the filling tank 326, or in both the pumping chamber 318 and the filling tank 326, is low, the control system 306 may transmit an alert to the remote receiver 912 of the user, alerting the user to add water to the watering system 304.

As shown in FIGS. 7-9, modular garden systems of the present technology may include at least one light source 400. The light source 400 may be attached to the base panel 308, and may include a neck 402 and a lamp 404 having a light 406. The neck may extend away from the base panel 308, and be configured to direct the light 406 onto the plants growing in the modular planter 302. The light 406 may be a full spectrum light, or any other type of light suitable for promoting plant growth. The light source 400 may be operatively connected to the control system 306. The operative connection may be wired or wireless. The control system 306 may operate the light source, by turning on or off the light, according to a schedule, or as appropriate to promote plant growth.

As shown in FIG. 10, modular garden systems of the present technology may include an air system 700. The air system 700 may include an air pump 702, and an air pathway 704 connected to the air pump 702 that terminates in one or more air stones 706. When the air pump is on, it may direct air through the air pathway 704 and into one water contained in or more plant pod receivers 310. The air pump may be operatively connected to the control system 306. The operative connection may be wired or wireless. The control system 306 may operate the air system 700, by turning on or off the air pump 702, according to a schedule, or as appropriate to reduce algae growth in the water and/or to promote plant growth. Alternatively, the air pump may constantly be turned on.

FIG. 14 illustrates one example of a plant pod 800 that can be used with modular garden system 300. The plant pod 800 has a housing 802, a plant growth opening 806. Inside the plant pod 800, there is a plant growth substrate 804. The plant growth substrate 804 may be a bio-foam, which may be biodegradable. Plant pod 800 also contains one or more seeds or seedlings, not shown. As the one or more seeds or seedlings grow, the resulting plant or plants protrude through the plant growth opening 806.

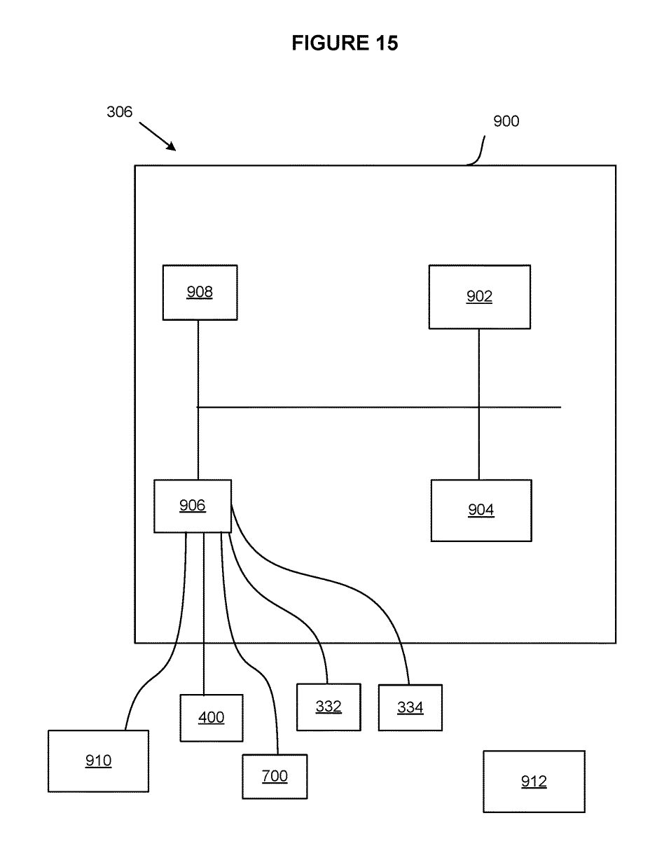

FIG. 15 illustrates one example of a control system 306 that can be used with modular garden system 300. The control system 306 may include a housing 900. The control system 306 includes a processor 902, a non-volatile computer readable memory 904, a receiver 906, a transmitter 908, and at least one sensor 910. Each sensor 910 may be located in contact with at least one plant pod receiver 310, and may be operatively connected to the receiver 906 of the control system 106. The operative connection may be wired, or wireless. As discussed above, the control system 306 may also be operatively connected to the light source 400, the air system 700, and the first and second sensors 332 and 334 of the watering system 304. The non-volatile computer readable memory 904 may store computer readable instructions, such as software code, that when executed by the processor 902, cause the control system 306 to operate the modular garden system 300, including the watering system 304. For example, when sensor 910 sends a signal to the receiver 906, indicating that the moisture level in a plant pod receiver 310 is low, the control system 306 may cause the pump 328 of the watering system 304 to pump water into the channels 324, to provide water to the plant pod receiver 310. The control system 306 may also send data from the transmitter 908 to a remote receiver 912, such as a user smartphone or other personal computing device.

The at least one sensor 910 can be a plant condition sensor. Each plant condition sensor 910 may measure one or more conditions relating to plants in the modular planter, including the humidity of the soil, the ambient temperature, and the amount of light the plants receive. Each plant condition sensor 910 may collect data and transmit the data to the control system 306.

The modular garden system 300 may optionally include one or more software applications that can be run on the remote receiver 912, such as a user's personal computing device. The one or more software applications may allow the user to share the status of plants on social media and establish relationships with other users in a geographic vicinity. Information that can be shared between users includes, for example, plant production information, tips on modular gardening and modular garden operation, and recipes. In at least one example, users may be provided with an account that allows them to log into a central system to communicate with other users, access an on-line store for modular garden components, plants and related merchandise, and participate in a rewards program that provides points unable in the on-line store.

### EXAMPLE

In one example, a modular garden of the present technology has been provided, in which each of the components has the following specifications:

Modular Planter

| | |
|---|---|
| HEIGHT | 18.50″ |
| LENGTH | 15.75″ |
| WIDTH | 2.36″ |
| WEIGHT | 2.11 lbs |
| CAPACITY | 12 plant pods |
| FRAME MATERIAL | HDPE |
| FRAME COLOR | white |
| GROWING MEDIUM | smart bio_foam |
| INTERLOCKABLE | in all directions |
| INDOOR/OUTDOOR | yes |
| SOIL-FREE | yes |
| DIRT-LESS GROWING | yes |
| EASY-TO-INSTALL | yes |

Water Collector

| | |
|---|---|
| HEIGHT | 2.79″ |
| LENGTH | 15.75″ |
| WIDTH | 2.36″ |
| WEIGHT | 0.8 lbs |
| CASE MATERIAL | HDPE |
| CASE COLOR | white |
| WATER CAPACITY | 0.5 gallons |
| INTERLOCKABLE | horizontaly |
| EASY-TO-DRAIN SYSTEM | yes |
| ALLOWS YOU TO RECYCLE WATER | yes |
| KEEPS YOUR SPACE CLEAN | yes |
| EASY-TO-INSTALL | yes |
| INDOOR/OUTDOOR | yes |

Plant Pod

| | |
|---|---|
| HEIGHT | 6.30″ |
| LENGTH | 4.00″ |
| WIDTH | 1.57″ |
| WEIGHT | 0.07 lbs |
| CASE MATERIAL | HDPE |
| CASE COLOR | white |
| GROWING MEDIUM | smart bio_foam |
| VARIETY | 36 species |
| EXPIRATION BEFORE OPENING | 12 months |
| RECYCLE PROGRAM | yes |
| PRE-SEEDED | yes |
| INDOOR GROWING ALL YEAR | yes |
| GMO | No |
| HERBICIDES | No |
| PESTICIDES | No |
| GERMINATION GUARANTEED | yes |
| AVERAGE GERMINATION TIME | 7-14 days |
| AVERAGE TIME FOR HARVESTING | 6-8 weeks |
| INDOOR/OUTDOOR | yes |

Watering System

| | |
|---|---|
| HEIGHT | 9.61″ |
| LENGTH | 15.04″ |
| WIDTH | 2.99″ |
| WEIGHT | 1.29 lbs |
| CASE MATERIAL | HDPE |
| CASE COLOR | white |
| WATER CAPACITY | 1.20 gallons |
| AUTONOMY WATERING | 30 days |
| BATTERY | 9 V alkaline |
| BATTERY LIFE | 6 months |
| TIMER PROGRAMS | 4 settings |
| ELECTRONIC VALVE | 9 volts |
| FILLING TIME | 1 minute |
| AUTOMATIC WATERING | yes |
| WATER OPTIMIZATION | yes |
| WATER PER | 120 ml |
| IRRIGATION | |
| INDOOR/OUTDOOR | yes |

SMART SENSOR

| | |
|---|---|
| HEIGHT | 3.15″ |
| LENGTH | 3.74″ |
| WIDTH | 0.39″ |
| WEIGHT | 0.2 lbs |
| CASE MATERIAL | HDPE |
| CASE COLOR | white |
| MOISTURE SENSOR | yes |
| TEMPERATURE SENSOR | yes |
| LIGHT SENSOR | yes |
| CONNECTIVITY | Bluetooth low- |
| | energy |
| TRANSMITS DATA TO | yes |
| SMARTPHONE | |
| IOS/ANDROID | yes |
| COMPATIBLE | |
| VISUAL ALERT | LED green light |
| BATTERY | AAA (2) |
| BATTERY LIFE | 6 months |
| INDOOR/OUTDOOR | yes |

User Device Software Application

| | |
|---|---|
| COST | free |
| IOS/ANDROID COMPATIBLE | yes |
| PLANT DATA BASE | 36 species |
| USER FRIENDLY | yes |
| VISUAL ALERTS | yes |
| TELLS YOU WHAT TO DO WITH | yes |
| YOUR P&P | |
| SENDS YOU TIPS FROM EXPERTS | yes |
| YOU CAN SHARE YOUR | yes |
| EXPERIENCE | |
| EASY-TO-USE | yes |
| TRACKS AND MONITORS YOUR | yes |
| P&P | |

The housing for each of the components may be made of recyclable plastic, recycled plastic, or any other suitable material.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A modular garden system comprising:
a modular planter;
a watering system operatively connected to the modular planter; and
a control system operatively connected to the watering system.

2. The modular garden system of claim 1, further comprising a water collector connected to the modular planter.

3. The modular garden system of claim 1, wherein the modular planter comprises at least one base panel configured to be attached to a surface, and one or more plant pod receivers, each plant pod receiver being configured to slidably receive and contain a plant pod.

4. The modular garden system of claim 3, further comprising a light source attached to the base panel.

5. The modular garden system of claim 4, wherein the light source is operatively connected to the control system, and the control system operates the light source.

6. The modular garden system of claim 3, wherein each plant pod receiver comprises a back wall including a growth substrate.

7. The modular garden system of claim 6, wherein the plant pod comprises a housing, a plant growth opening on a front side of the housing, a substrate interface on a back side of the housing, and a plant growth substrate contained within the housing.

8. The modular garden system of claim 1, wherein each base panel comprises at least one channel connected to the watering system, wherein each channel receives water from a reservoir of the watering system and provides the received water to at least one plant pod.

9. The modular garden system of claim 1, wherein the control system comprises:
a processor;
a non-volatile computer readable memory operatively connected to the processor;
a receiver operatively connected to the processor and the memory;
a transmitter operatively connected to the processor and the memory; and
at least one sensor operatively connected to the receiver, the sensor being located in contact with at least one plant pod.

10. The modular garden system of claim 9, wherein the non-volatile computer readable memory stores computer readable instructions that, when executed by the processor, cause the control system to operate the modular garden system.

11. The modular garden system of claim 9, wherein the control system is configured to send data from the transmitter to a remote receiver.

12. The modular garden system of claim 1, wherein the watering system comprises:
a reservoir having an inlet and an outlet; and
at least one channel connected to the outlet, wherein the at least one channel is configured to convey water from the outlet to at least one plant pod.

13. The modular garden system of claim 12, wherein the reservoir comprises a filling tank and a pumping chamber.

14. A modular garden system comprising:
a modular planter including at least one base panel configured to be attached to a surface, and one or more plant pod receivers, each plant pod receiver being configured to slidably receive and contain a plant pod;
a watering system operatively connected to the modular planter; and
a control system operatively connected to the watering system.

15. The modular garden system of claim 14, further comprising at least one plant pod slidably received in one of the plant pod receivers.

16. The modular garden system of claim 14, wherein the plant pod comprises a housing having a plant growth opening, and a plant growth substrate contained within the housing.
